(19) United States
(12) Patent Application Publication
(10) Pub. No.: US 2022/0309287 A1
(43) Pub. Date: Sep. 29, 2022

(54) DETECT FIELD INTERACTIONS BASED ON RANDOM TREE STUMPS

(71) Applicant: International Business Machines Corporation, Armonk, NY (US)

(72) Inventors: Jing Xu, Xi'an (CN); Xue Ying Zhang, Xi'an (CN); Si Er Han, Xi'an (CN); Xiao Ming Ma, Xi'an (CN); Ji Hui Yang, Beijing (CN)

(21) Appl. No.: 17/210,803

(22) Filed: Mar. 24, 2021

(51) Int. Cl. G06K 9/62; G06N 5/00

(52) U.S. Cl. CPC G06K 9/6256; G06K 9/6228; G06K 9/6298; G06K 9/6202; G06N 5/003

(57) ABSTRACT

An approach is provided in which a method, system, and program product generate a set of bootstrap samples from a set of data records that each includes multiple fields. The method, system, and program product create a set of decision tree stumps from the set of bootstrap samples. Each one of the set of decision tree stumps includes multiple leaf nodes corresponding to one or more of the multiple fields. The method, system, and program product generate a set of new features from the set of decision tree stumps, wherein each one of the set of new features indicates at least one field interaction between two or more of the multiple fields. The method, system, and program product train a predictive model based on the set of new features.

### BACKGROUND

Predictive modeling is a process that uses data and statistics to predict outcomes with data models. Predictive modeling is often referred to as predictive analytics, predictive analysis, and machine learning. Machine learning (ML) is the study of computer algorithms that improve automatically through experience. Machine learning algorithms build a model based on sample data, known as “training data,” to make predictions or decisions without being explicitly programmed.

Predictive models use data that typically includes several variables, also referred to as “fields” or “features.” A predictive model training stage identifies features corresponding to characteristics of a particular field. Another important component during the training stage is identifying interactions between the fields. Field interactions are direct insights about the data and help to understand the truth behind the data to build effective models.

Existing solutions, however, require users to manually specify field interactions (e.g. in linear regression models). In linear regression, relationships are modeled using linear predictor functions whose unknown model parameters are estimated from the data. Linear regression focuses on a conditional probability distribution of a response given the values of the predictors rather than on a joint probability distribution of all of the variables in the domain of multivariate analysis.

In addition, some existing solutions detect bivariate interactions based on a heuristic research approach. Bivariate analysis involves the analysis of two variables (X, Y) for the purpose of determining an empirical relationship between the two variables. Bivariate analysis is helpful in testing simple hypotheses of associations.

A challenge found with today's approaches to identify field interactions is that today's approaches become difficult when applied to higher dimensions (e.g. #fields>3) due to the massive amount of combinations in the number of potential interactions in predictive model analysis.

### BRIEF SUMMARY

According to one embodiment of the present disclosure, an approach is provided in which a method, system, and program product generate a set of bootstrap samples from a set of data records that each includes multiple fields. The method, system, and program product create a set of decision tree stumps from the set of bootstrap samples. Each one of the set of decision tree stumps includes multiple leaf nodes corresponding to one or more of the multiple fields. The method, system, and program product generate a set of new features from the set of decision tree stumps, and each one of the set of new features indicates at least one field interaction between two or more of the multiple fields. The method, system, and program product train a predictive model based on the set of new features.

According to another embodiment of the present disclosure, an approach is provided in which a method, system, and program product select a first one of the set of bootstrap samples, which includes a set of the multiple fields. The method, system, and program product assign a first field from the set of fields as a target field and build a first one of the set of decision tree stumps from the first bootstrap sample using the target field as a root node. The first decision tree stump includes a set of the multiple leaf nodes. The method, system, and program product encode the first decision tree stump based on the set of fields corresponding to the set of leaf nodes, and generate a first one of the new features based on the encoded first decision tree stump.

According to yet another embodiment of the present disclosure, an approach is provided in which a method, system, and program product select a first leaf node from the set of leaf nodes. The first leaf node is based on a threshold value of a second one of the multiple fields. The method, system, and program product determine a target value of the target field at the first leaf node based on a probability value of the target field at the first leaf node. The method, system, and program product include the threshold value of the second field and the target value of the target field in the encoding of the first decision tree stump.

According to yet another embodiment of the present disclosure, an approach is provided in which a method, system, and program product compute a quality measure of each of the set of new features, and rank the set of new features based on their corresponding quality measure. The method, system, and program product select a portion of the set of new features to train the predictive model based on their corresponding ranking.

According to yet another embodiment of the present disclosure, an approach is provided in which a method, system, and program product select a first new feature from the set of new features, which includes a target value of a target field. The method, system, and program product test the first new feature against the set of data records, which generates a set of test results based on comparing the target value against a field value in the set of data records. The method, system, and program product compute the quality measure of the new feature based on the set of test results.

According to yet another embodiment of the present disclosure, an approach is provided in which a method, system, and program product identify at least one of the multiple leaf nodes that have a probability value of the target field exceeding a probability threshold. The method, system, and program product generate a report that indicates the identified at least one leaf node.

According to yet another embodiment of the present disclosure, an approach is provided in which a method, system, and program product generate a set of features from the set of data records based on the multiple fields. The method, system, and program product train the predictive model utilizing the set of features and the set of new features.

According to yet another embodiment of the present disclosure, an approach is provided in which a method, system, and program product utilize at least one million bootstrap samples in the set of bootstrap samples. The method, system, and program product also set a tree depth less than four for each of the set of decision tree stumps.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary high level diagram showing a system that generates new field interaction features and trains a predictive model using the generated new field interaction features;

FIG. 4 is an exemplary diagram showing details of generating a bootstrap sample from training data and then generating a decision tree stump from the bootstrap sample;

FIG. 5 is an exemplary diagram showing steps to encode leaf nodes in a tree stump;

FIG. 6 is an exemplary diagram showing a selection of the top N new field interaction features based on quality measures;

FIG. 7 is an exemplary diagram showing a system utilizing a trained predictive model for new data predictions;

FIG. 8 is an exemplary flowchart showing steps taken to generate new field interaction features and use the new field interaction features to build predictive models and data understanding; and

FIG. 9 is an exemplary flowchart showing steps taken to generate new features from decision tree stumps.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

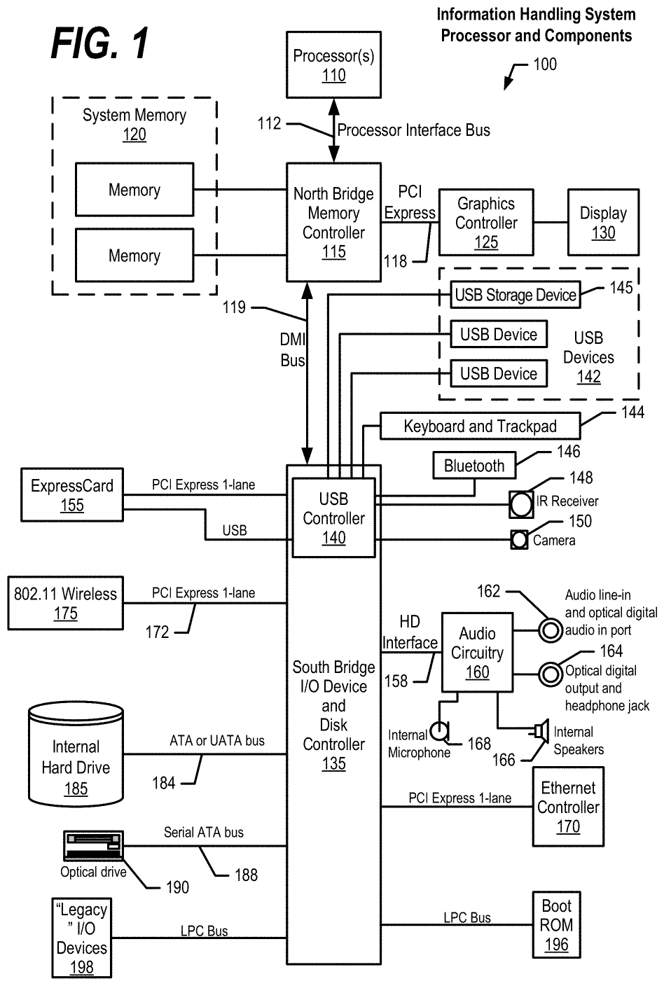

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

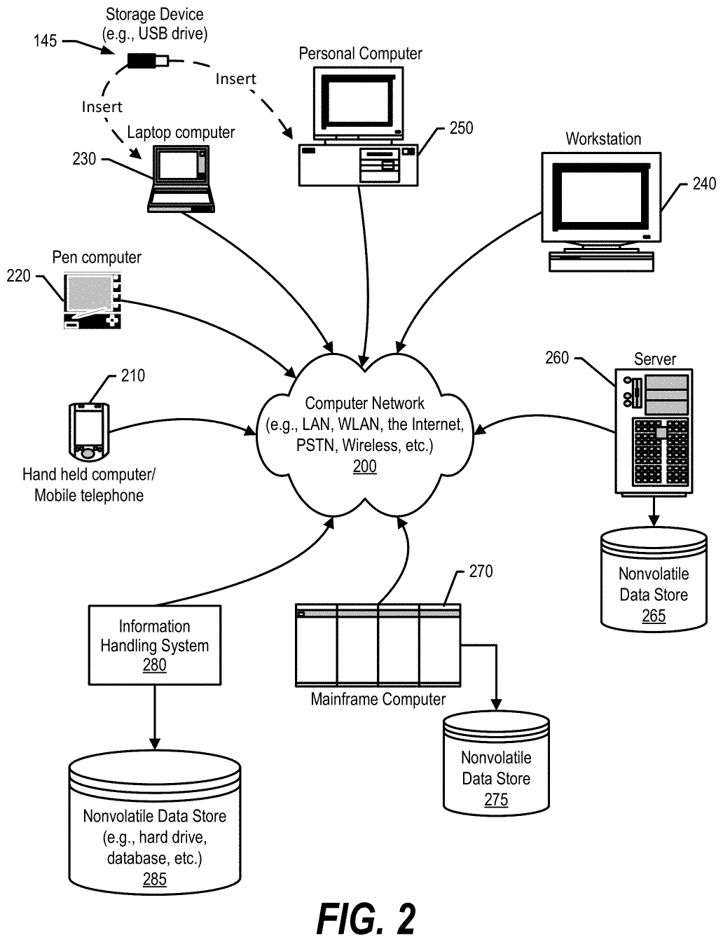

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

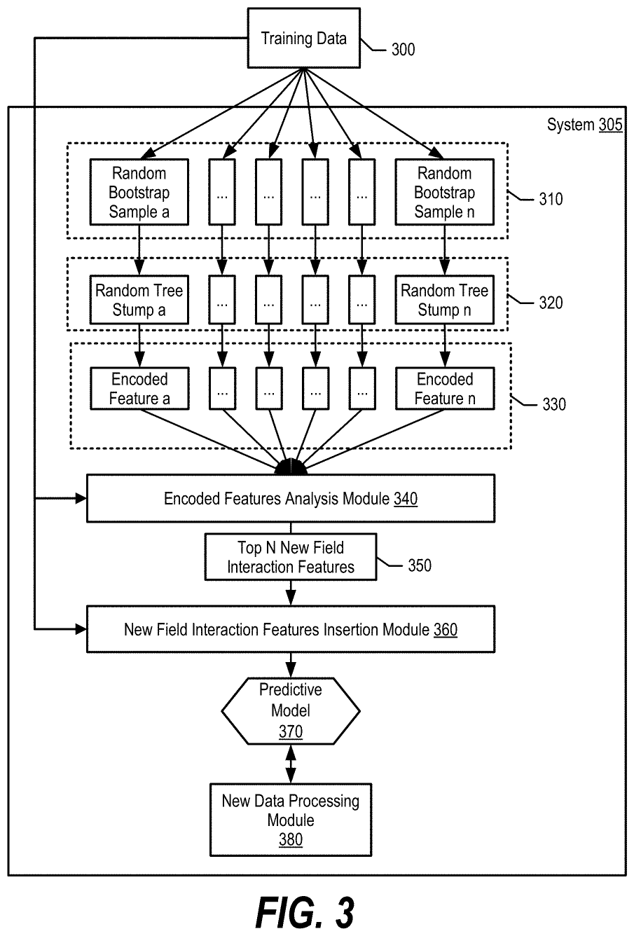

As discussed above, field interactions play an important in understanding data and building predictive models. Existing solutions detect bivariate interactions based on a heuristic research, but this approach becomes difficult when applied to higher dimensions (e.g. >3) due to the massive amount of combinations in the number of potential interactions in predictive model analysis. FIGS. 3 through 9 depict an approach that can be executed on an information handling system that generates random tree stumps to detect field interactions. Tree stumps are decision trees with a limited depth, such as less than three. The approach leverages the benefit of decision trees and, due to the capability of interpretation of trees, the interactions identified by the approach are well interpretative and are not constrained by dimensions. In addition, the approach discussed herein can execute in parallel to reduce computation time.

As discussed in detail below, the approach i) generates random bootstrap samples from original data; ii) builds a tree stump on each bootstrap sample; iii) encodes the leaf nodes in each tree stump; iv) ranks the tree stumps by a quality measure; v) identifies the top N best tree stumps; vi) creates a set of features based on the encoded tree stumps; and vii) uses the set of features to train a predictive model and perform data exploration. The approach discussed herein applies to many practical applications, such as predictive modeling, and provides several advantages over existing solutions. First, the approach is not constrained by the amount of fields under analysis to generate new field interaction features. Second, generating the bootstrap samples, generating the tree stumps, and encoding the tree stumps can be executed in parallel to reduce overall model training time. Third, the approach is not a random search but, instead, identifies data interaction insights using a tree-based heuristic search.

FIG. 3 is an exemplary high level diagram showing a system that generates new field interaction features and trains a predictive model using the generated new field interaction features, also referred to herein as new features. As discussed herein, system 305 identifies important field interactions from decision tree stumps and uses the identified field interactions as new predictors to enhance predictive model 370 and improve data exploration.

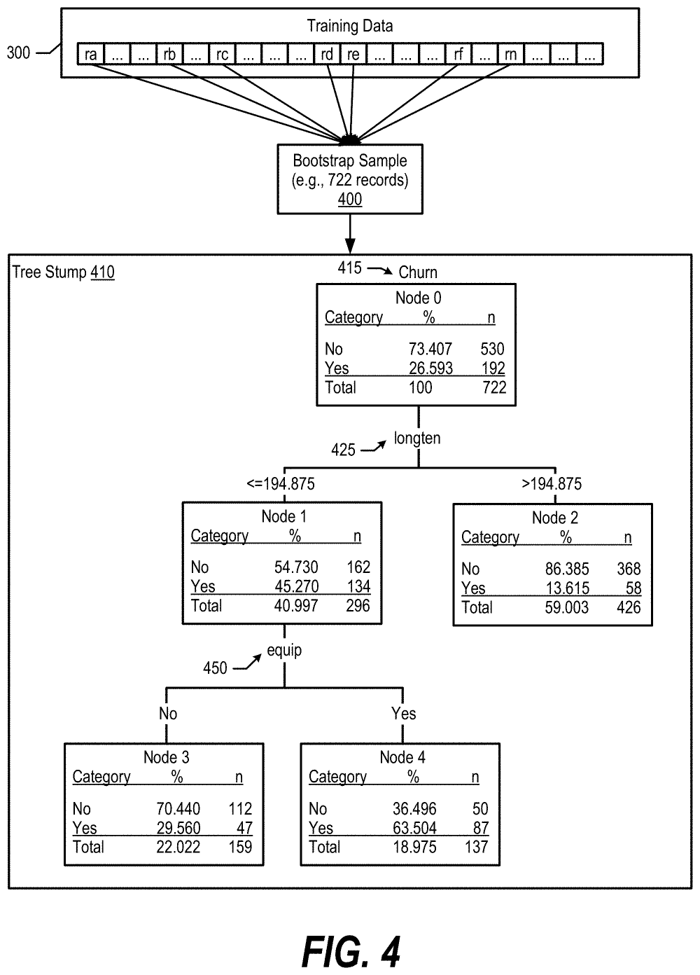

Training data 300, in one embodiment, includes a large amount of data records (e.g., over one million). The data records include various variables, also referred herein as fields or features. System 305 randomly selects a large amount of samples from training data 300 to generate each of random bootstrap samples 310 (e.g., random bootstrap sample “a,” see FIG. 4 and corresponding text for further details). A random bootstrap sample is a smaller sample that is “bootstrapped” from a larger sample (training data 300). Bootstrapping is a type of resampling where large numbers of smaller samples of the same size are repeatedly drawn, with replacement, from a single original sample. In one embodiment, system 305 generates random bootstrap samples 310 in parallel to minimize processing time. The number of random bootstrap samples 310 is adjustable and, in one embodiment, equals the size of the training data (e.g., over one million).

System 305 then uses a decision tree algorithm to create random tree stumps 320 (also referred to herein as random decision tree stumps) from random bootstrap samples 310. As discussed herein, a tree stump is a decision tree with limited layers (e.g., two or three). System 305 generates random tree stumps 320 because, compared to other algorithms, decision tree algorithms require less effort for data preparation during pre-processing; do not require normalization of data; and do not require scaling of data (see FIG. 4 and corresponding text for further details).

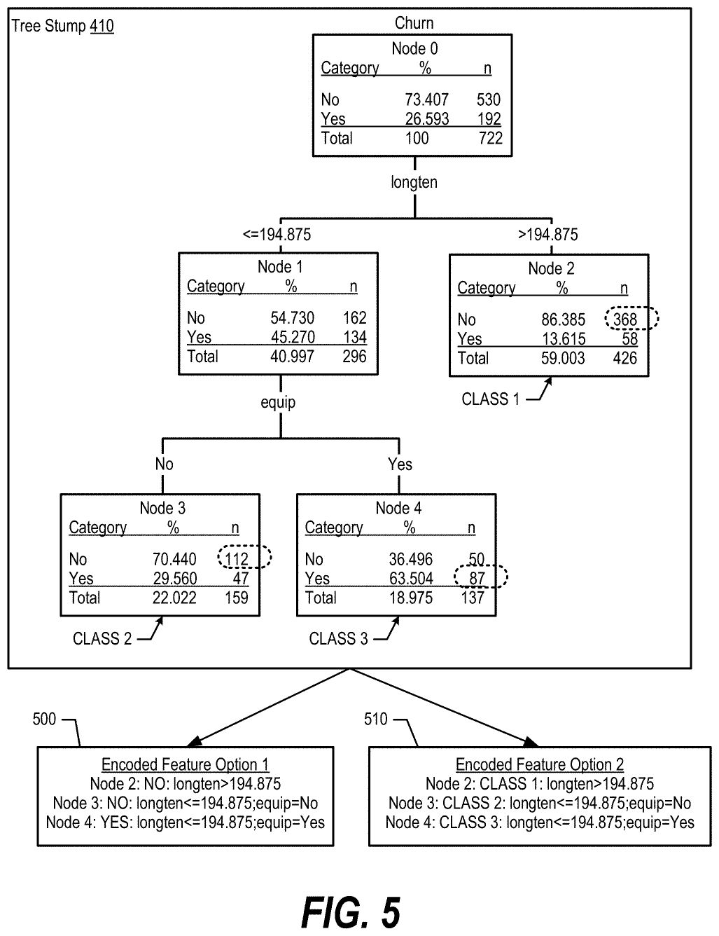

Next, system 305 encodes features in random tree stumps 320 based on fields included in their corresponding leaf nodes (stumps) to generate encoded features 330. In one embodiment, system 305 encodes the random tree stumps in parallel to minimize processing time and may utilize various encoding approaches (see FIG. 5 and corresponding text for further details).

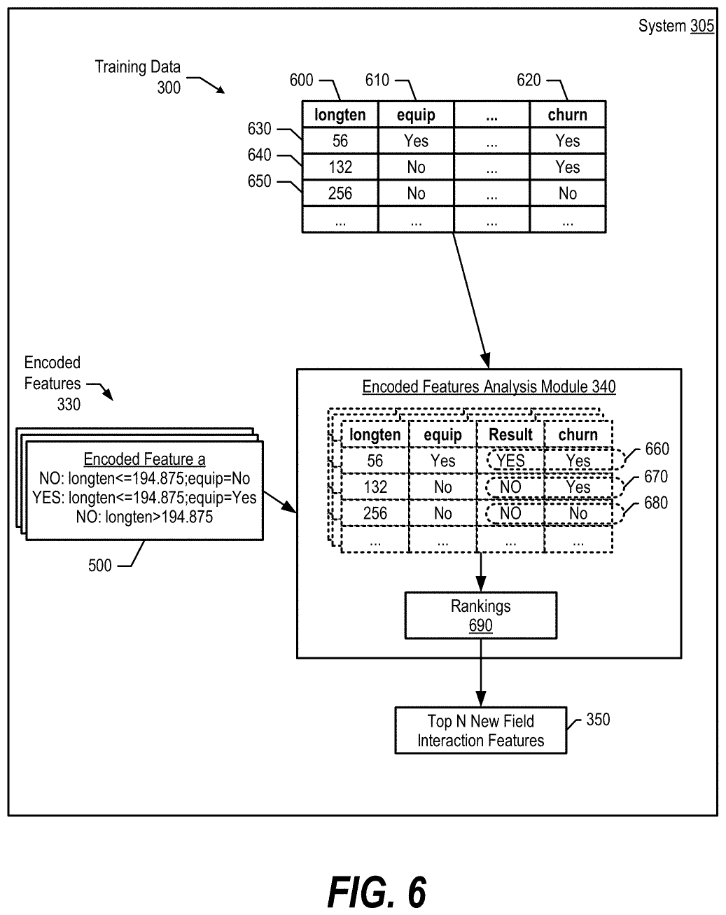

System 305's encoded features analysis module 340 then evaluates the new field interaction features and ranks the new field interaction features based on various criteria. In one embodiment, system 305 computes a quality measure for each encoded feature based on a prediction accuracy that system 305 computes on a particular data. For example, system 305 captures predictions from encoded features 330 and compares the predictions against observed values. The process then utilizes the comparison to compute a prediction accuracy (e.g., quality measure, see FIG. 6 and corresponding text for further details).

In another embodiment, system 305 explores the leaf nodes in tree stumps 320 for data understanding. In one embodiment, because tree leaf nodes correspond to particular decision rules, a leaf node with a high purity is interesting and valuable to apply specific treatment. In other words, system 305 searches for leaf nodes that have a probability value greater than a probability threshold (e.g., >80%). For example, marketing/retention specialist are interested in a leaf node that indicates 90% of the time that event A (e.g., buy a product) occurs if event B occurs (e.g., targeted advertising).

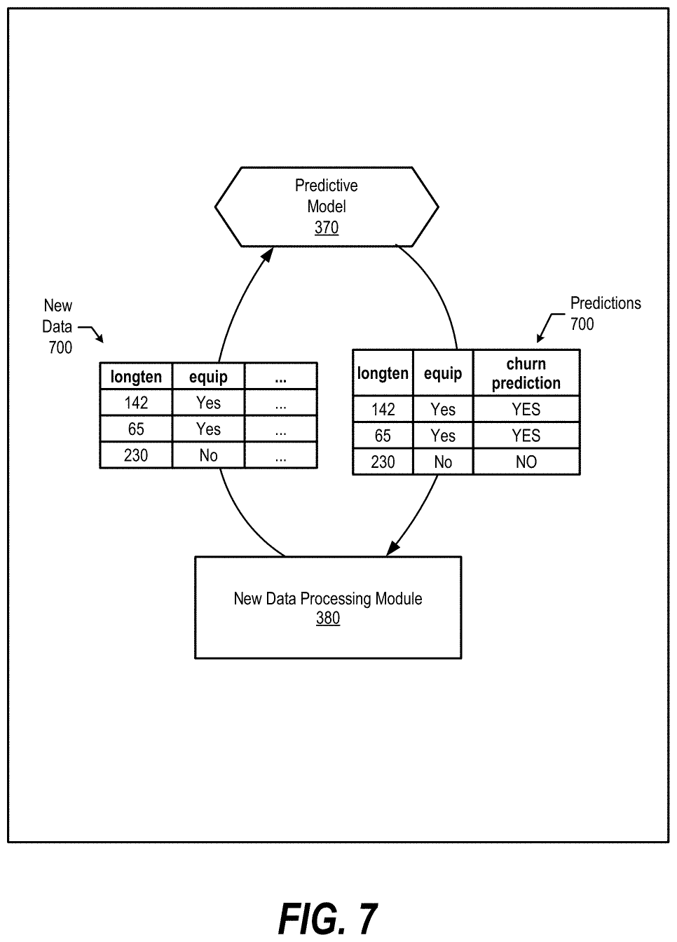

System 305 then selects the top N new field interaction features 350 based on the rankings and, in one embodiment, inserts the new field interaction features via new field interaction features insertion module 360) into training data 300, which system 305 then utilize to train predictive model 370. In another embodiment, system 305 inputs top N new field interaction features 350 into predictive model 370 in parallel with training data 300 to train predictive model 370 (see FIG. 6 and corresponding text for further details). Once trained, new data processing module 380 uses predictive model 370 to generate predictions of new data (see FIG. 7 and corresponding text for further details).

FIG. 4 is an exemplary diagram showing details of generating a bootstrap sample from training data and then generating a decision tree stump from the bootstrap sample. Training data 300 includes a large amount of records each having a number of features (e.g., fields, variables). A feature is a measurable property of the object under analysis and, in datasets, features typically appear as columns. Each feature, or column, represents a measurable piece of data that can be used for analysis. Features are the basic building blocks of datasets, and the quality of the features has a major impact on the quality of the insights gained when the dataset is used for machine learning.

The example in FIG. 4 shows that system 305 randomly selects 722 data records from training data 300 to create bootstrap sample 400. Bootstrap sample 400 is part of random bootstrap samples 310 and, as discussed herein, each of random bootstrap samples 310 may be generated in parallel. Next, system 305 use decision tree algorithms to generate tree stump 410 from bootstrap sample 400 based on a target field indicated by the user (churn 415) and staying within a maximum tree depth. Decision tree algorithms are supervised learning algorithms that have a pre-defined target variable and are mostly used in non-linear decision making with simple linear decision surface.

Tree stump 410 shows that churn 415 is the target field selected by the user. Node 0 is the root node and shows that there are 722 total samples in bootstrap sample where 530 have a “No” churn value and 192 have a “Yes” churn value. Node 0 then branches to node 1 and node 2 based on a threshold value (194.875) compared against the value of longten field 425 in the data samples. If a data sample's longten field value is <=194.875 then the data sample falls in node 1. If a data sample's longten field value is >194.875 then the data sample falls in node 2.

Node 2 shows that 426 of the 722 data samples have a longten field value >194.875. Of those data samples, 368 have a No churn value and 58 have a Yes churn value. Node 2 is a leaf node and, as discussed herein, is eventually encoded by system 305 using various techniques. Node 2 shows that if a data sample's longten field value is >194.875, then the data sample's churn target value is assigned a “No” value because the No value has a higher probability than the Yes value (see FIG. 5 and corresponding text for further details).

Node 1 shows that 296 of the 722 data samples have a longten field value <=194.875. Of those data samples, 162 have a “No” churn value and 134 have a “Yes” churn value. Node 1 then branches to nodes 3 and nodes 4 based on equip field 450 value within the 296 data samples from node 1.

Node 3 shows that 159 of the 296 data samples from node 1 have a equip value of “No.” Of the 159 samples, 112 also have a churn value of “No” and 47 have a churn value of “Yes.” Node 4 shows that 137 of the 296 data samples from node 1 have a equip value of “Yes.” Of the 137 samples, 50 samples also have a churn value of “No” and 87 have a churn value of “Yes.”

Node 3 and node 4 are leaf nodes and, as discussed herein, are encoded by system 305 using various techniques. Node 3 shows that if a data sample's longten field value is <=194.875 and its equip value is No, then based on probabilities the data sample's churn target value is assigned a “No” value. Node 4 shows that if a data sample's longten field value is <=194.875 and its equip value is Yes, then based on probabilities the data sample's churn target value is assigned a “Yes” value (see FIG. 5 and corresponding text for further details).

FIG. 5 is an exemplary diagram showing tree stump leaf node encoding. Tree stump 410 is generated from bootstrap sample 400 in FIG. 4 and includes three leaf nodes, which are nodes 2, 3, and 4. System 305 may use different approaches to encode tree stump 410, two of which are shown in FIG. 5.

Encoded feature option 1 500 shows that each leaf node is assigned by the prediction corresponding to the leaf node. Node 2 is assigned a “No” target value because there is a higher probability (probability value) that a particular data set's churn value will be “No” if the data set has a longten value >194.875. Node 3 is assigned a “No” target value because there is a higher probability (probability value) that a particular data set's churn value will be “No” if the data set has a longten value <=194.875 and an equip value of “No.” Node 4 is assigned a “Yes” target value because there is a higher probability (probability value) that a particular data set's churn value will be “Yes” if the data set has a longten value <=194.875 and an equip value of “Yes.”

Encoded feature option 2 510 shows that each leaf node is assigned a distinct category (e.g., classes). Node 2 is assigned a class 1 category. Node 3 is assigned a class 2 category. And, node 4 is assigned a class 3 category.

FIG. 6 is an exemplary diagram showing system 305 selecting the top N new field interaction features based on quality measures. In one embodiment, system 305 use encoded features analysis module 340 to analyze the large amount of encoded features 330 generated from the large amount of decision tree stumps 320. In this embodiment, and as discussed below, encoded features analysis module 340 analyzes the predictions in encoded features 330 against the actual training data 300 to determine the prediction accuracy of encoded features 330.

Training data 300 includes data sets 630, 640, and 650. Each data set includes values for longten field 600, equip field 610, and churn field 620. To test the accuracy of encoded feature 500, encoded features analysis module 340 applies encoded feature 500 to each of data sets 630, 640, and 650, particularly fields 600 and 610. Comparison 660 shows that the churn prediction result of data set 630 is YES, which is correct. Comparison 670 shows that the churn prediction result of data set 640 is NO, which is incorrect. And, comparison 680 shows that the churn prediction result of data set 650 is No, which is correct. Based on the three data sets, the quality measure of encoded feature 500 is 66.67% (2 out of 3 correct).

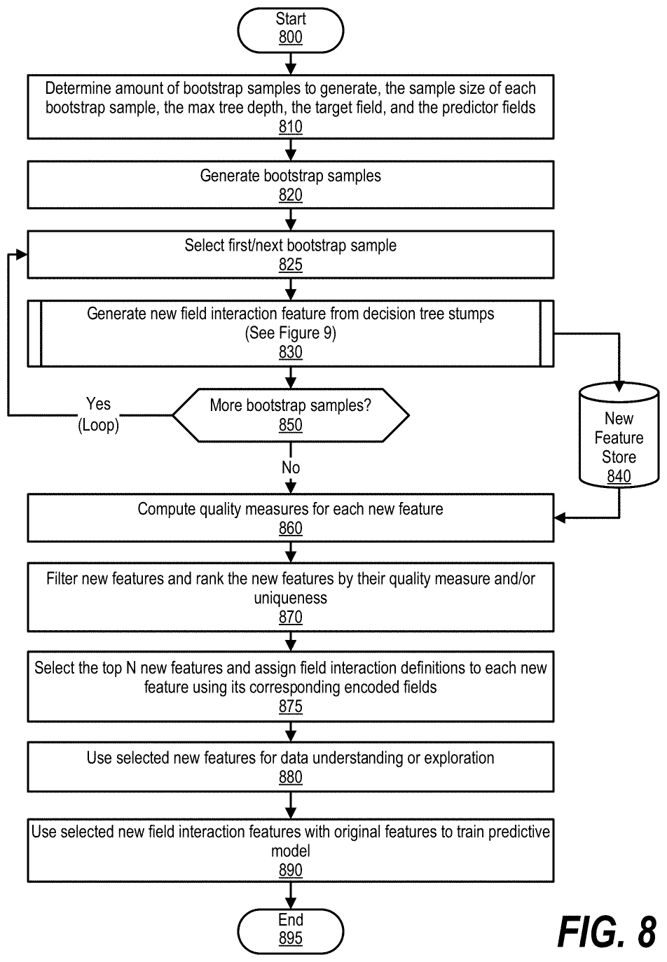

Encoded features analysis module 340 performs a similar quality measure for each of encoded features 330 and uses rankings module 690 to rank encoded features 330 accordingly. In turn, encoded features analysis module 340 outputs top N new field interaction features 350, which are subsequently utilized to train predictive model 370 (see FIG. 8 and corresponding text for further details).

FIG. 7 is an exemplary diagram showing system 305 utilizing trained predictive model 370 for new data predictions. New data processing module 380 inputs new data 700 into predictive model 370. New data 700 includes longten field values, equip field values, and other field values, but does not include churn field values.

Predictive model 370 analyzes each of the data sets in new data 700 and generates a churn value prediction (predictions 700) based on the training of new field interaction features as discussed herein.

FIG. 8 is an exemplary flowchart showing steps taken to generate new field interaction features and use the new field interaction features to build predictive models and data understanding. FIG. 8 processing commences at 800 whereupon, at step 810, the process determines, or receives input from a user, an amount of bootstrap samples to generate, the sample size of each bootstrap sample, the maximum decision tree stump depth, a target field, and various predictor fields. Referring back to FIGS. 4 and 5, the “churn” field is the target field and the other fields are initially considered predictors. The set of predictors that are utilized during a particular tree stump generation stump depends on the tree growth algorithm. The utilized predictors may also be different across the different decision tree stumps because each decision tree stump grows on different samples.

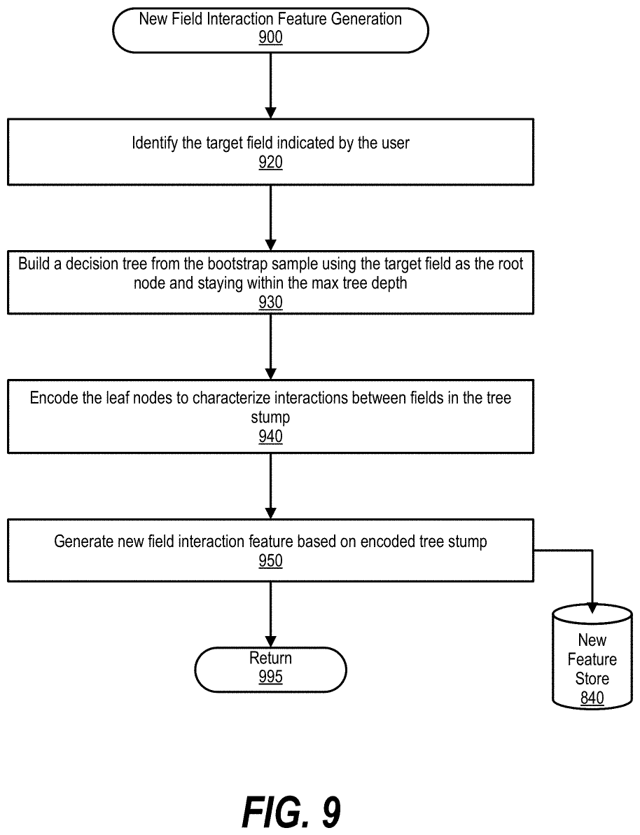

At step 820, the process generates bootstrap samples by randomly selecting data records from original data 300. Referring to FIG. 5, the process randomly retrieves 722 records from original data 300 and generates bootstrap sample 500. At step 825, the process selects the first bootstrap sample and, at step 830, the process builds a decision tree stump from the selected bootstrap sample, generates a new feature (new field interaction feature) from encoding the decision tree stump, and stores the new feature in new feature store 840 (pre-defined process block 830, see FIG. 9 and corresponding text for further details).

The process determines as to whether there are more bootstrap samples to process (decision 850). If there are more bootstrap samples to process, then decision 850 branches to the ‘yes’ branch which loops back to select and process the next bootstrap sample. This looping continues until there are no more bootstrap samples to process, at which point decision 850 branches to the ‘no’ branch exiting the loop.

At step 860, the process computes quality measures for each new feature. In one embodiment, the quality measure is based on a prediction accuracy that the process computes on a particular data. For example, the process may capture the predictions from a generated decision tree stump and then compare the predictions with observed values. The process then utilizes the comparison to compute a prediction accuracy (see FIG. 6 and corresponding text for further details). At step 870, the process filters the new field interaction features and ranks the new features by their quality measure and/or uniqueness.

At step 875, the process selects the top N new features based on the rankings and assigns the selected top N new features as new field interaction features using their corresponding encoded fields. In one embodiment, the process also identifies the leaf nodes that are unusual in terms of their distributions from the overall distribution of the target, such as when the accuracy of the leaf node exceeds a probability threshold (e.g., greater than 80%).

At step 880, the process uses the selected new field interaction features for data understanding or exploration. In other words, as discussed above, the process searches for leaf nodes that have a probability value greater than a probability threshold (e.g., >80%). In one embodiment, the process generates a report that identifies the new features with a high probability value. At step 890, the process uses the selected new field interaction features as new predictors along with the original features to build and train predictive model 350. FIG. 8 processing thereafter ends at 895.

FIG. 9 is an exemplary flowchart showing steps taken to generate new field interaction features from decision tree stumps. The steps shown in FIG. 9 may be performed in parallel on multiple bootstrap samples. FIG. 9 processing commences at 900 whereupon, at step 920, the process identifies the target field indicated by the user and, at step 930, the process builds a decision tree stump from the bootstrap sample using the target field as the root node and staying within the max tree depth (see FIG. 5 and corresponding text for further details).

During the tree building step, the process splits each node by the best predictor field among a subset of fields that are randomly selected from the overall field, such as by using a random forest algorithm. In one embodiment, the tree based searching strategy is not totally random, but follows a supervised learning mechanism. In this embodiment, interactions between features are not easy to identify, particularly if the number of features is high. The feasibility to try every combination is impractical because the number of different combinations exponentially increases with the number of features. As such, a heuristic approach is useful and a tree-based searching strategy may be utilized.

At step 940, the process encodes the leaf nodes in the tree stump to characterize interactions between fields in the tree stump. As shown in FIG. 6, the process may use various encoding approaches to characterize the field interactions. At step 950, the process generates a new field interaction feature based on the encoded decision tree stump. FIG. 9 processing thereafter returns to the calling routine (see FIG. 8) at 995. The advantages of the steps shown in FIG. 9 over prior approaches is that the steps are not constrained by the amount of fields in the data samples. Instead, the steps shown in FIG. 9 bring to the surface the interactions between features regardless of the amount of fields under analysis.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A computer-implemented method comprising:
generating a set of bootstrap samples from a set of data records each comprising a plurality of fields;
creating a set of decision tree stumps from the set of bootstrap samples, wherein each one of the set of decision tree stumps comprises a plurality of leaf nodes corresponding to one or more of the plurality of fields;
generating a set of new features from the set of decision tree stumps, wherein each one of the set of new features indicates at least one field interaction between two or more of the plurality of fields; and
training a predictive model based on the set of new features.

2. The computer-implemented method of claim 1 further comprising:
selecting a first one of the set of bootstrap samples, wherein the first bootstrap sample comprises a set of fields from the plurality of fields;
assigning a first field from the set of fields as a target field;
building a first one of the set of decision tree stumps from the first bootstrap sample using the target field as a root node, wherein the first decision tree stump comprises a set of leaf nodes from the plurality of leaf nodes;
encoding the first decision tree stump based on the set of fields corresponding to the set of leaf nodes; and
generating a first one of the new features based on the encoded first decision tree stump.

3. The computer-implemented method of claim 2 wherein the encoding further comprises:
selecting a first leaf node from the set of leaf nodes, wherein the first leaf node is based on a threshold value of a second one of the plurality of fields;
determining a target value of the target field at the first leaf node based on a probability value of the target field at the first leaf node; and
including the threshold value of the second field and the target value of the target field in the encoding of the first decision tree stump.

4. The computer-implemented method of claim 1 further comprising:
computing a quality measure of each of the set of new features;
ranking the set of new features based on their corresponding quality measure; and
selecting a portion of the set of new features to train the predictive model based on their corresponding ranking.

5. The computer-implemented method of claim 4 wherein the computing of the quality measure further comprises:
selecting a first new feature from the set of new features, wherein the first new feature comprises a target value of a target field;
testing the first new feature against the set of data records, wherein the testing compares the target value against a field value in the set of data records, and wherein the testing generates a set of test results; and
computing the quality measure of the new feature based on the set of test results.

6. The computer-implemented method of claim 1 further comprising:
identifying at least one of the plurality of leaf nodes in one of the set of decision tree stumps that comprises a probability value of the target field exceeding a probability threshold; and
generating a report that indicates the identified at least one leaf node.

7. The computer-implemented method of claim 1 further comprising:
generating a set of features from the set of data records based on the plurality of fields; and
training the predictive model utilizing the set of features and the set of new features.

8. The computer-implemented method of claim 1 wherein:
the set of bootstrap samples comprise at least one million bootstrap samples; and
each of the set of decision tree stumps comprise a tree depth less than four.

9. An information handling system comprising:
one or more processors;
a memory coupled to at least one of the processors;
a set of computer program instructions stored in the memory and executed by at least one of the processors in order to perform actions of:
generating a set of bootstrap samples from a set of data records each comprising a plurality of fields;
creating a set of decision tree stumps from the set of bootstrap samples, wherein each one of the set of decision tree stumps comprises a plurality of leaf nodes corresponding to one or more of the plurality of fields;
generating a set of new features from the set of decision tree stumps, wherein each one of the set of new features indicates at least one field interaction between two or more of the plurality of fields; and
training a predictive model based on the set of new features.

10. The information handling system of claim 9 wherein the processors perform additional actions comprising:
selecting a first one of the set of bootstrap samples, wherein the first bootstrap sample comprises a set of fields from the plurality of fields;
assigning a first field from the set of fields as a target field;
building a first one of the set of decision tree stumps from the first bootstrap sample using the target field as a root node, wherein the first decision tree stump comprises a set of leaf nodes from the plurality of leaf nodes;
encoding the first decision tree stump based on the set of fields corresponding to the set of leaf nodes; and
generating a first one of the new features based on the encoded first decision tree stump.

11. The information handling system of claim 10 wherein the processors perform additional actions comprising:
selecting a first leaf node from the set of leaf nodes, wherein the first leaf node is based on a threshold value of a second one of the plurality of fields;
determining a target value of the target field at the first leaf node based on a probability value of the target field at the first leaf node; and
including the threshold value of the second field and the target value of the target field in the encoding of the first decision tree stump.

12. The information handling system of claim 9 wherein the processors perform additional actions comprising:
computing a quality measure of each of the set of new features;
ranking the set of new features based on their corresponding quality measure; and
selecting a portion of the set of new features to train the predictive model based on their corresponding ranking.

13. The information handling system of claim 12 wherein the processors perform additional actions comprising:
selecting a first new feature from the set of new features, wherein the first new feature comprises a target value of a target field;
testing the first new feature against the set of data records, wherein the testing compares the target value against a field value in the set of data records, and wherein the testing generates a set of test results; and
computing the quality measure of the new feature based on the set of test results.

14. The information handling system of claim 9 wherein the processors perform additional actions comprising:
identifying at least one of the plurality of leaf nodes in one of the set of decision tree stumps that comprises a probability value of the target field exceeding a probability threshold; and
generating a report that indicates the identified at least one leaf node.

15. The information handling system of claim 9 wherein the processors perform additional actions comprising:
generating a set of features from the set of data records based on the plurality of fields; and
training the predictive model utilizing the set of features and the set of new features.

16. The information handling system of claim 9 wherein:
the set of bootstrap samples comprise at least one million bootstrap samples; and
each of the set of decision tree stumps comprise a tree depth less than four.

17. A computer program product stored in a computer readable storage medium, comprising computer program code that, when executed by an information handling system, causes the information handling system to perform actions comprising:
generating a set of bootstrap samples from a set of data records each comprising a plurality of fields;
creating a set of decision tree stumps from the set of bootstrap samples, wherein each one of the set of decision tree stumps comprises a plurality of leaf nodes corresponding to one or more of the plurality of fields;
generating a set of new features from the set of decision tree stumps, wherein each one of the set of new features indicates at least one field interaction between two or more of the plurality of fields; and
training a predictive model based on the set of new features.

18. The computer program product of claim 17 wherein the information handling system performs further actions comprising:
selecting a first one of the set of bootstrap samples, wherein the first bootstrap sample comprises a set of fields from the plurality of fields;
assigning a first field from the set of fields as a target field;
building a first one of the set of decision tree stumps from the first bootstrap sample using the target field as a root node, wherein the first decision tree stump comprises a set of leaf nodes from the plurality of leaf nodes;
encoding the first decision tree stump based on the set of fields corresponding to the set of leaf nodes; and
generating a first one of the new features based on the encoded first decision tree stump.

19. The computer program product of claim 18 wherein the information handling system performs further actions comprising:
selecting a first leaf node from the set of leaf nodes, wherein the first leaf node is based on a threshold value of a second one of the plurality of fields;
determining a target value of the target field at the first leaf node based on a probability value of the target field at the first leaf node; and
including the threshold value of the second field and the target value of the target field in the encoding of the first decision tree stump.

20. The computer program product of claim 17 wherein the information handling system performs further actions comprising:
computing a quality measure of each of the set of new features;
ranking the set of new features based on their corresponding quality measure; and
selecting a portion of the set of new features to train the predictive model based on their corresponding ranking.

21. The computer program product of claim 20 wherein the information handling system performs further actions comprising:
selecting a first new feature from the set of new features, wherein the first new feature comprises a target value of a target field;
testing the first new feature against the set of data records, wherein the testing compares the target value against a field value in the set of data records, and wherein the testing generates a set of test results; and
computing the quality measure of the new feature based on the set of test results.

22. The computer program product of claim 17 wherein the information handling system performs further actions comprising:
identifying at least one of the plurality of leaf nodes in one of the set of decision tree stumps that comprises a probability value of the target field exceeding a probability threshold; and
generating a report that indicates the identified at least one leaf node.

23. The computer program product of claim 17 wherein the information handling system performs further actions comprising:
generating a set of features from the set of data records based on the plurality of fields; and
training the predictive model utilizing the set of features and the set of new features.

24. A computer-implemented method comprising:
generating a set of bootstrap samples from a set of data records each comprising a plurality of fields;
creating a set of decision tree stumps from the set of bootstrap samples, wherein each one of the set of decision tree stumps comprises a plurality of leaf nodes corresponding to one or more of the plurality of fields, and wherein the creating further comprises:
selecting a first one of the set of bootstrap samples, wherein the first bootstrap sample comprises a set of fields from the plurality of fields;
assigning a first field from the set of fields as a target field;
building a first one of the set of decision tree stumps from the first bootstrap sample using the target field as a root node, wherein the first decision tree stump comprises a set of leaf nodes from the plurality of leaf nodes; and
encoding the first decision tree stump based on the set of fields corresponding to the set of leaf nodes;
generating a set of new features from the set of decision tree stumps, wherein each one of the set of new features indicates at least one field interaction between two or more of the plurality of fields and wherein a first one of the new features is based on the encoded first decision tree stump;
training a predictive model based on the set of new features; and
utilizing the trained predictive model to generate one or more predictions based on one or more new data records.

25. An information handling system comprising:
one or more processors;
a memory coupled to at least one of the processors;
a set of computer program instructions stored in the memory and executed by at least one of the processors in order to perform actions of:
generating a set of bootstrap samples from a set of data records each comprising a plurality of fields;
creating a set of decision tree stumps from the set of bootstrap samples, wherein each one of the set of decision tree stumps comprises a plurality of leaf nodes corresponding to one or more of the plurality of fields, and wherein the creating further comprises:
selecting a first one of the set of bootstrap samples, wherein the first bootstrap sample comprises a set of fields from the plurality of fields;
assigning a first field from the set of fields as a target field;
building a first one of the set of decision tree stumps from the first bootstrap sample using the target field as a root node, wherein the first decision tree stump comprises a set of leaf nodes from the plurality of leaf nodes; and
encoding the first decision tree stump based on the set of fields corresponding to the set of leaf nodes;
generating a set of new features from the set of decision tree stumps, wherein each one of the set of new features indicates at least one field interaction between two or more of the plurality of fields and wherein a first one of the new features is based on the encoded first decision tree stump;
training a predictive model based on the set of new features; and
utilizing the trained predictive model to generate one or more predictions based on one or more new data records.
